(19) United States
(12) Patent Application Publication
(10) Pub. No.: US 2004/0039839 A1
(43) Pub. Date: Feb. 26, 2004

(54) Connectionless internet traffic engineering framework

(76) Inventors: Shivkumar Kalyanaraman, Niskayuna, NY (US); Hema Tahilramani H.T., Santa Clara, CA (US); Jayasri Akella, Troy, NY (US); Satish Raghunath, Troy, NY (US); Karthikeya Chandrayana, Troy, NY (US); Hemang Nagar, Troy, NY (US)

Correspondence Address: RATNERPRESTIA, P O BOX 980, VALLEY FORGE, PA, 19482-0980, US

(21) Appl. No.: 10/361,539

(22) Filed: Feb. 10, 2003

Related U.S. Application Data
(60) Provisional application No. 60/356,032, filed on Feb. 11, 2002.

(51) Int. Cl. G06F 15/173

(52) U.S. Cl. 709/238

(57) ABSTRACT

A method is provided for routing a packet to a third node in a network of nodes connected by links, the network including first and second nodes. The method includes receiving, in the second node, the packet from the first node, the packet including a value representing a route of nodes connected by links to a destination node. The method also includes modifying, in the second node, the received value to produce a modified value representing another route of nodes connected by links to the destination node. The method also includes transmitting the packet including the modified value, from the second node to the third node.

### RELATED APPLICATIONS

This application claims priority of U.S. Provisional Application Serial No. 60/356,032, filed on Feb. 11, 2002.

### FIELD OF THE INVENTION

The present invention relates, in general, to a method and system for routing information between nodes, and more specifically, to a connectionless framework in which a node may select a path from multiple paths for routing information between nodes on the Internet.

### BACKGROUND OF THE INVENTION

Traffic engineering (TE) relates to the issue of performance evaluation and performance optimization of operational IP networks in Internet network engineering. In order to enhance performance, traffic is typically routed in a manner that utilizes network resources efficiently and reliably. The term “traffic engineering” is used to imply a range of objectives, including but not limited to, load-balancing, constraint-based routing, multi-path routing, fast re-routing and protection switching. Most work in the area of TE has focussed on solving one or more of these within a single, flat routing domain (or area).

Two broad classes of routing models conventionally used for routing and traffic engineering are 1) a hop-by-hop model (distance-vector (DV), path-vector (PV) and link-state (LS)) and 2) a signaled model (implemented in MPLS ATM and frame-relay).

In the hop-by-hop model, local knowledge is distributed to immediate neighbors, and ultimately reaches all nodes. Every node infers routes based upon this information. A consistency criterion ensures that the independent decisions made by nodes lead to valid, loop-free routes. The forwarding algorithm in this model is related to the control-plane algorithm because both use the same global identifiers (e.g., addresses, prefixes, link metrics, AS numbers). This relationship conventionally requires changes in the forwarding algorithm whenever the control-plane algorithm is significantly changed (e.g., subnet masking, CIDR). Hop-by-hop routing protocols, however, dominate the control-plane of the Internet (e.g., RIP, EIGRP, OSPF, IS-IS, BGP) for three important reasons. Firstly, they support connectionless forwarding. Secondly, they can be inter-networked easily. Thirdly, they scale reasonably well. Traffic engineering capabilities in the hop-by-hop model, though attempted, have not found wide adoption in the Internet. Source routing in this model typically requires that the entire path be enumerated in the packet. This is an undesirable overhead (e.g., IP, IPv6 options for strict/loose source route). Multi-path algorithms for this model typically utilize the cooperation and upgrade of all routers in the network. Further, the decision of traffic-splitting is typically done in an ad-hoc manner at intermediate nodes without source control.

In the signaled model, local knowledge may be sent to all nodes through an approach similar to hop-by-hop algorithms. In the signaled model, however, the source node or some central entity a) computes the desired paths and b) decides what traffic is mapped to those paths. The intermediate nodes (switches) then set up local path identifiers (e.g., “labels” in MPLS) for the paths. The signaling protocol allows autonomy in the choice of labels at switches, but ensures consistency between label assignments at adjacent switches in the path. This leads to a label-switching forwarding algorithm where labels are switched at every hop. The forwarding algorithm in the signaled model is typically de-coupled from the control algorithms. This is because the forwarding algorithm uses local identifiers (labels), whereas the control algorithms use global identifiers (addresses). The signaling protocol maps and ensures consistency between local and global identifiers. This de-coupling between forwarding and control-planes allows introduction of new TE capabilities by modifying the control plane. Signaled approaches, however, have been hard to inter-network (e.g., IP over ATM, Non-Broadcast Multiple Access (NBMA) routing, or multi-domain signaled TE), and hence have been limited to intra-domain or intra-area deployments (e.g., MPLS, ATM).

### SUMMARY OF THE INVENTION

In an exemplary embodiment of the present invention, a method of routing a packet to a third node in a network of nodes connected by links, the network including first and second nodes, is provided. The method includes receiving, in the second node, the packet from the first node, the packet including a value representing a route of nodes connected by links to a destination node. The method also includes modifying, in the second node, the received value to produce a modified value representing another route of nodes connected by links to the destination node. The method also includes transmitting the packet including the modified value, from the second node to the third node.

In another exemplary embodiment of the present invention, a node configured to communicate in a network of nodes connected by links is provided. The node includes a receiver configured to concurrently receive a packet of data and a path ID from a previous node, where the path ID represents a desired route for the packet of data, the desired route transversing nodes that are connected by links to a destination node. The node also includes a memory configured to store multiple path suffix IDs, each path suffix ID representing a possible route for the packet of data from the node to the destination node. The node also includes a processor configured to modify the received path ID using the multiple path suffix IDs stored in the memory. The node also includes a transmitter configured to concurrently transmit the packet of data and the modified path ID to a next node disposed along one of the possible routes.

In yet another exemplary embodiment of the present invention, a machine-readable storage medium is provided. The machine-readable storage medium contains a set of instructions for causing a node, configured to receive and transmit packets in a communication network of nodes connected by links, to perform various steps, including: (a) receiving a packet from a previous node, the packet including both a payload and a value representing a desired route of nodes connected by links to a destination node; (b) modifying the received value to produce a modified value representing another route of nodes connected by links to the destination node; and (c) transmitting the packet including both the payload and the modified value to a next node along the other route.

### BRIEF DESCRIPTION OF THE DRAWINGS

The invention is best understood from the following detailed description when read in connection with the accompanying drawings. This emphasizes that according to common practice, the various features of the drawings are not drawn to scale. On the contrary, the dimensions of the various features are arbitrarily expanded or reduced for clarity. Included in the drawings are the following features:

FIG. 1 is an illustration of a network of nodes connected by links showing a route between nodes i and j, in accordance with an exemplary embodiment of the present invention;

FIG. 2 is an illustration of another network showing multiple routes amongst nodes, in accordance with an exemplary embodiment of the present invention;

FIG. 3 is an illustration of yet another network including area border routers (ABRs), in accordance with an exemplary embodiment of the present invention;

FIG. 4 is a flow diagram illustrating a method of an originating node inserting a path ID into a packet header, in accordance with an exemplary embodiment of the present invention;

FIG. 5 a flow diagram illustrating a method of an intermediate node inserting another path ID into a packet header, in accordance with an exemplary embodiment of the present invention;

FIG. 6 is a flow diagram illustrating a method of a node selecting a route and path ID based on multi-path capability, in accordance with an exemplary embodiment of the present invention;

FIG. 7 is an illustration of yet another network including entry and exiting AS-border routers (BRs) in accordance with an exemplary embodiment of the present invention;

FIG. 8 is an illustration of yet another network including AS-BRs in accordance with an exemplary embodiment of the present invention;

FIG. 9 is a flow diagram illustrating a method of inter-domain routing used by an exiting AS-BR, in accordance with an exemplary embodiment of the present invention;

FIG. 10 is a flow diagram illustrating a method of inter-domain routing used by an entry AS-BR, in accordance with an exemplary embodiment of the present invention;

FIG. 11 is a block diagram illustrating nodes communicating in a network, in accordance with an exemplary embodiment of the present invention;

FIG. 12 is an illustration of a data packet, in accordance with an exemplary embodiment of the present invention; and

FIG. 13 is an algorithm for computing all paths between a source node and a destination node in accordance with an exemplary embodiment of the present invention.

### DETAILED DESCRIPTION OF THE INVENTION

In an exemplary embodiment of the present invention, a connectionless framework is provided for both intra-domain and inter-domain traffic engineering (TE) in the Internet. Advantages of this framework, provided through various exemplary embodiments, are a) it allows the source node to discover multiple paths and decide on how to split traffic among paths (assuming forwarding extensions in a subset of routers), b) it does not require signaling, or high per-packet overhead, c) it enables an incremental upgrade strategy for both intradomain (OSPF) and inter-domain (BGP) routing to support TE capabilities, and d) in a fully upgraded network, every source may control how traffic is mapped to paths and, therefore, network-wide traffic engineering objectives may be achieved.

As will be explained, a path to a destination address is specified in a fixed-length Path ID field in the packet header. Path ID may be defined as the sum of link weights on the path (or the sum of Autonomous System (AS) numbers for inter-domain paths). This encoding allows efficient connectionless forwarding, without using a signaling protocol. Extensions to OSPF and BGP may be used to support the connectionless framework. Further, a multi-path computation algorithm, as well as traffic splitting techniques and forwarding extensions, are illustrated through various embodiments of the present invention.

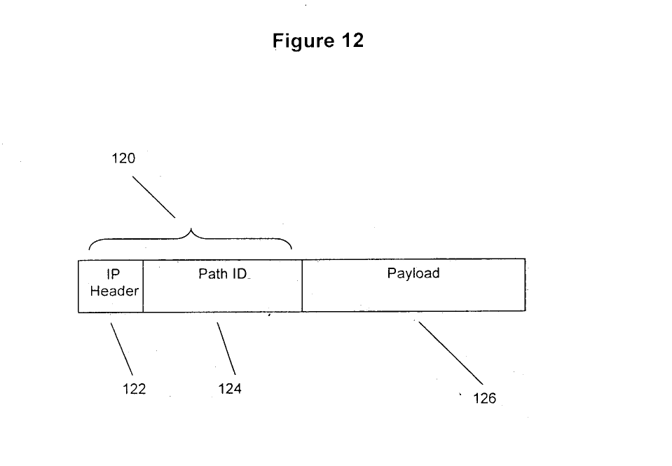

FIG. 12 illustrates a data packet in accordance with the present invention. The data packet includes header 120 and payload 126 (i.e., data field 126). Header 120 includes IP header 122 and Path ID 124. The present invention implements the path ID in different ways, as exemplified in the embodiments discussed below.

The connectionless framework of the present invention provides for the incremental deployment of TE capabilities for both intra-domain and inter-domain settings within the hop-by-hop (or connectionless) routing model on the Internet. The present invention efficiently utilizes network resources by using multi-path routing. An exemplary embodiment includes multi-path computation and forwarding (at intermediate nodes) and multi-path computation (or discovery) and traffic-splitting (at the source). The source, for example, refers to a node in the data-path that makes multi-path computation (or discovery) and traffic splitting decisions on behalf of a traffic originator (i.e., the source host). Upgraded intermediate nodes provide next-hop forwarding to implement the source's path selection decision. With partial upgrades, a subset of sources may benefit from these capabilities. With a fully upgraded network, every source may control how traffic is mapped to different paths or routes.

The connectionless framework of the invention allows sources to compute (or discover) multiple paths within a connectionless routing model and decide on how to split traffic among these paths. Further, the invention allows a subset of nodes to participate in the TE process, i.e., with partial upgrades. Further still, the invention provides path encoding to specify the path as a short, fixed-length field in a packet, and includes a corresponding forwarding algorithm. Additionally, the present invention provides for mapping the connectionless framework to current intra and inter-domain protocols (e.g. OSPF, BGP). The present invention includes a provision for examining preliminary options for various sub-blocks of the connectionless framework (e.g. multi-path and traffic splitting algorithms for partially upgraded networks).

The connectionless framework of the present invention does not replace MPLS based TE within a routing domain, but may provide an alternative to non-MPLS routing domains which currently deploy OSPF or IS-IS. The connectionless framework of the present invention provides an incremental upgrade strategy for connectionless TE, and supports a broad set of TE capabilities for the inter-domain case in the Internet. In fact, MPLS-TE within an AS (or area) may be complemented with the connectionless framework of the present invention across autonomous systems.

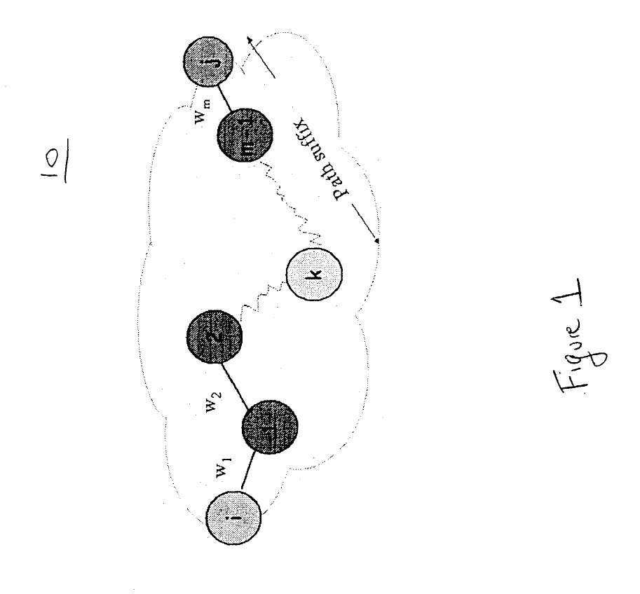

FIG. 1 illustrates network 10 modeled as a graph with links and nodes, where links are given weights (not necessarily unique). The path from node i to node j passes through links of weights w₁, w₂, . . . , wₘ. In an embodiment of the invention, the PathID of the path from node i to node j may be defined as follows:

PathID(i, j, w₁, . . . , wₘ)=(w₁+w₂+ . . . wₖ . . . wₖ₊₁ . . . +wₘ)mod 2^{b}

where b bits are used to encode the PathID. The PathID may be included as a field in a packet header, as shown in FIG. 12. The PathID may alternatively be defined as a sum of node identifiers, instead of the sum of link weights. The path ID may also be defined as a combination of node identifiers and link weights. Such definitions are useful in mapping the framework to BGP-4, wherein PathID may be defined as a sum of autonomous system numbers (ASNs). The tuple (destination address, PathID(i, j, w₁, . . . , wₘ)) at node i defines the path to the destination. This tuple is also referred to herein as the forwarding tuple, or in a shorthand form, (Destination, PathID).

Assuming that the forwarding tuples (Destination, PathID) are unique, if the link weights vary between a sufficiently large range (i.e., take diverse values of path IDs), the forwarding tuples (Destination, PathID) may likely be unique. Since both link weight and AS number may be 16-bit fields, any reasonably diverse assignment of link weights suffices to achieve uniqueness. The uniqueness probability, of course, depends on the size of the network and connectivity. However, if the forwarding tuple (Destination, PathID) is non-unique (i.e., tuple collision does occur) the router may apply a local heuristic (e.g., hashing) to map this traffic to the paths with the same forwarding tuple.

In FIG. 1, if k is an intermediate node on a path from i to j, a residual path from k to j may be labeled as the path suffix. For example, the PathSuffixID from node k to node j may be defined as follows:

PathSuffixID(k, j, wₖ₊₁, . . . , wₘ)=PathID(k, j, wₖ₊₁, . . . , wₘ)=(wₖ₊₁ . . . +wₘ)mod 2^{b}

At any intermediate node k, each path suffix to a destination prefix may be stored in a forwarding table as (destination prefix, next-hop, PathSuffixID), where PathSuffixID is the PathID computed for the path suffix shown in FIG. 1. The forwarding table entry may be indexed by processing the destination address and PathID fields in incoming packet headers. The PathID field in a packet may be initialized at the source to allow source-based control of traffic splitting to paths on a packet-by-packet basis. Intermediate nodes honor the path selection choice of the source in a best-effort manner.

The packet-forwarding algorithm (with some changes) may be mapped to both the intra-domain case, as well as the inter-domain case, and may be summarized as follows.

Intermediate nodes find the longest destination address prefix match first, and then the nearest PathID match among paths to that destination. Nearest PathID matches the largest PathSuffixID less than or equal to the PathID on the packet, or the PathID of the default path. Once this match is found, nodes may update the header PathID field by subtracting the next-hop link weight from it (modulo 2^{b}), and forward the packet.

If the PathID field is smaller than the smallest PathSuffixID, then the PathID field is set to the value of the smallest PathSuffixID minus the next-hop weight before forwarding.

Routers that do not support multiple paths ignore the PathID field. These routers look at the destination address field and apply the longest-prefix-match forwarding algorithm.

In a network where all nodes support multi-path forwarding, assuming that:

a) there exists a loop-free path from i to j through k, whose PathSuffixID at k is PathID(k, j, wₖ₊₁, . . . , wₘ), and next-hop is k+1;

b) the source has chosen an initial PathID W, and

c) the packet has crossed k links with weights w₁, w₂, . . . , wₖ, and after finding a nearest PathID match of PathID(k, j, wₖ₊₁, . . . , wₘ,),

then one of the following conditions (Condition 1, Condition 2) may be satisfied.

Condition 1: W≧{w₁+w₂+ . . . +wₖ+PathID(k, j, wₖ₊₁, . . . , wₘ)}mod2^{b} and PathID(k, j, wₖ₊₁, . . . , wₘ) is the largest PathSuffixID that satisfies the inequality,

Condition 2: W<{w₁+w₂+ . . . +wₖ+PathID(k,j,wₖ₊₁, . . . , wₘ)}mod2^{b} and PathID(k, j, wₖ₊₁, . . . , wₘ) is the PathSuffixID of the default path suffix (i.e., smallest PathSuffixID value).

If condition 1 is satisfied, wₖ₊₁ may be subtracted from the PathID field (modulo 2^{b}) before forwarding. If condition 2 is satisfied, the PathID field may be set to PathSuffixID(k, j, wₖ₊₁, . . . , wₘ)−wₖ₊₁ before forwarding. It will be appreciated that condition 2 maps packets with errant PathIDs to the shortest path. The packet is then forwarded to node k+1.

Keeping in mind the uniqueness assumption of PathIDs between any pair of nodes, the above assures a forwarding match. The inequality is preferred (rather than the equality) because of an assumption that a source may choose a path autonomously, and at intermediate nodes traffic to non-existent paths may be distributed among a set of available paths (and certainly mapped to a default path in the worst case). In BGP the default path need not be the shortest path.

It is interesting to compare the PathID to the label used in the signaled models, such as ATM and MPLS.

Firstly, the forwarding tuple (destination address, PathID) may be thought of as a globally significant path identifier, similar to an IP address being a globally significant interface ID and an IP prefix being a globally significant network ID. In contrast, the MILS label has only a local meaning, typically utilizing a signaling protocol to map labels to global addresses. The signaling utilization makes it hard to map a label-swapped routing system to OSPF and BGP. Interestingly, unlike addresses, non-unique forwarding tuples are possible (with a low probability).

Secondly, the PathID field by itself does not designate the path. Rather, it may be interpreted along with the destination address. In contrast, the label used in the signaled model is a stand-alone field.

Further, both PathID and labels may be updated at every (upgraded) hop; however, PathID is updated through a computation (e.g., a subtract operation) whereas a label is swapped with a completely new label based upon a label-table.

Further still, PathID may be defined in terms of link weights and/or node identifiers and may be mapped to intra- and inter-domain protocols with minor modifications as discussed herein. In contrast, the label-swapping and the signaled model are hard to map to current inter-domain protocols (BGP).

Additionally, though the use of the tuple (Destination address, PathID) relates the forwarding and control planes due to the use of global IDs, it gives a valuable handle (global path identifier) for TE functions. Given this handle, a range of TE control-plane functions may be deployed without any further forwarding-plane support at intermediate nodes. In MPLS, on the other hand, the use of local IDs (labels) for forwarding and global IDs (addresses) for control de-couples the two planes, and deployment of new TE control functions without affecting the forwarding plane.

Turning next to a single-area OSPF network with point-to-point links (i.e., no hierarchy). In such an embodiment, each upgraded node knows all other nodes which support multi-path capabilities. This knowledge may be achieved through a single-bit (multi-path capable or MPC bit) in the link-state advertisement (LSA), and may be zero by default. Multi-path capable routers may set their MPC bit to 1 in every LSA they originate.

Mapping to other link-state protocols, for example, IS-IS, is similar to OSPF. In distance-vector (DV) protocols (e.g., EIGRP) the PathID may be the “distance” of the chosen path. Consequently, a similar forwarding strategy to OSPF may be used, if nodes are upgraded for multi-path forwarding.

It will be appreciated that a problem in DV protocols, vis-a-vis multi-path computation under partial upgrades, is the lack of topology visibility. This problem leads to two issues: a) multi-path enabled nodes do not see which other nodes are multi-path capable, and b) nodes cannot figure out how to concatenate loop-free path segments such that the entire path is loop free.

Use of the invention in intra-domain multi-path forwarding is described next. The following different conditions are considered: (a) all nodes are multi-path capable, and (b) multi-path capable nodes use the same multi-path computation algorithm and support forwarding to all available routes to any destination. A single-area flat routing domain is used for these conditions. Furthermore, a third condition, in which a subset of nodes support multi-path capabilities, is considered. This third condition relates to a situation in which the upgraded nodes may use different multi-path computation algorithms and/or may support forwarding to only a limited number of paths. Last, a condition of hierarchical intra-domain multi-path routing is also described.

For the first condition, in which all nodes or routers in the network support multipath capabilities, the forwarding model described earlier may be utilized. In particular, for intra-domain operation, the IP packet header may be extended with a 32-bit field referred to herein as an i-PathID. A 32-bit field is sufficient to assure no wrap-around, because OSPF link metrics are 16-bit fields (i.e., the sum of at least 64K 16-bit numbers (>64K-hop paths) are required to wrap-around a 32-bit field). The i-PathID may be initialized by the host or the first-hop router that participates in multi-path routing and traffic splitting.

The initialization value of i-PathID in one embodiment, may be the sum of weights of links along the path modulo having a field space (2^{b}). The actual choice of a path for every packet, of course, depends upon the traffic splitting strategy. Intermediate routers, or nodes, may find the longest-prefix-match on a destination address, and a nearest PathID match (this may be an exact PathID match in steady state) of the received i-PathID to determine the next-hop. The i-PathID value in the received packet header is decremented by the value of the weight of the link, for example, to the next-hop before the packet is physically forwarded. When the packet reaches the destination, it may have an i-PathID value of zero. Of course, an i-PathID value smaller than the smallest PathID is re-mapped to the shortest path, with a new i-PathID corresponding to the shortest path. As such, even under transient routing conditions, the packet defaults to the shortest path.

Turning next to the partially upgraded network condition, in which not all nodes support multi-path computation and forwarding, the total number of paths to any destination is likely to be smaller. Moreover, nodes which do not support multi-path forwarding ignore the i-PathID field, and do not update it. If the originating node is not multipath enabled, the packet may be sent along a default (shortest) path and the routing option may not be used. In such case, the operator may configure a set of upgraded nodes to make multi-path decisions on behalf of hosts, if packets from those hosts flow through them. Otherwise, the forwarding may be the default IP forwarding.

If the originating node (source) is multi-path enabled, however, it first chooses a path for a packet. A slight variant in the forwarding process may then be used. Before forwarding the packet, it may decrement i-PathID by the sum of link weights (for example) of consecutive links until a multi-path or destination is reached. Essentially, the series of hops across non-upgraded nodes may be viewed as a single virtual-hop for the purposes of the iPathID decrementing function. Due to lack of topology or path visibility, this virtual-hop feature cannot be implemented in DV protocols (e.g., RIP, EIGRP), but may be implemented in PV protocols, such as BGP.

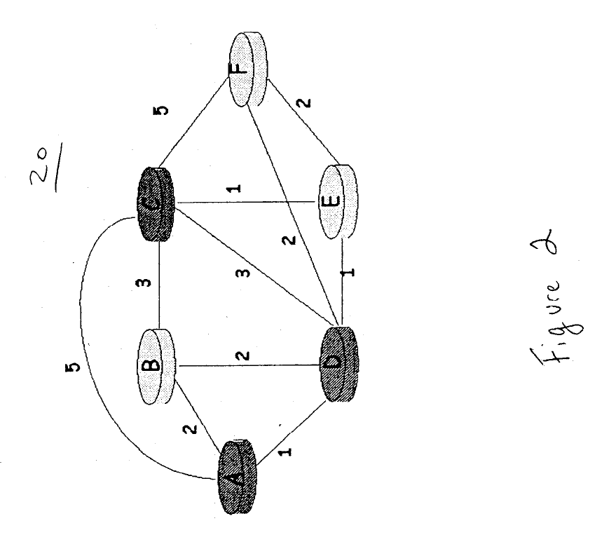

FIG. 2 illustrates an exemplary network, generally designated as 20, where nodes A, C and D are multipath enabled. Node A is the originating node for a packet destined to node F. The shortest path from intermediate node B to node F is B-D-F (with path weight of 4). Observe that the path A-B-C-F is not available for forwarding. Node B (which is not upgraded) cannot honor the path choice since the only possible next hop from B to destination F is node D. However, paths such as A-B-D-C-F, A-D-E-F, and A-D-C-E-F are available, because nodes A, C and D are multipath capable.

If path A-B-D-E-F is chosen, then the i-PathID is initially 7. However, because B does not support multi-path forwarding (and i-PathID update) capability, A sets i-PathID to 3. In other words, A views the pair of hops A-B and B-D as a single virtual-hop for the purpose of i-PathID update. Node B ignores the i-PathID field and forwards it on its perceived shortest-path (i.e., to D). Node D is multi-path enabled, and realizes that the next-hop should be E. However, since E is not multi-path capable, node D sets the i-Path ID to zero. Node E forwards the packet to F without looking at the i-PathID.

If path A-D-C-F is chosen, all nodes in the path are multipath capable, and hence the i-PathID value transmitted to D is 8. Node D updates i-PathID to 5 and sends it to node C. Node C updates i-PathID to 0, and forwards it to node F. It will be appreciated that this case is similar to the forwarding behavior in a fully-upgraded network, described before.

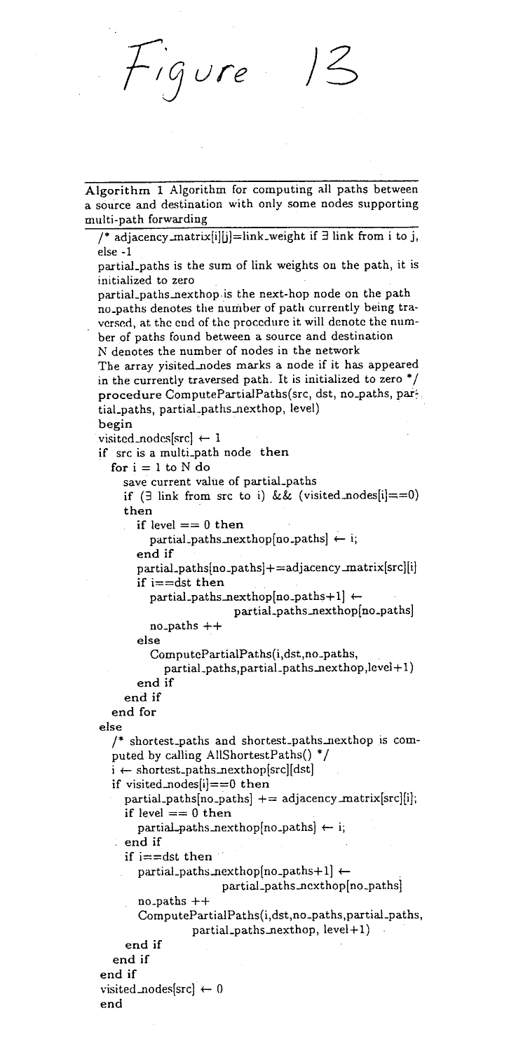

To enable this forwarding and update operation, the present invention provides a forwarding table at each upgraded node, which includes the following tuple: (Destination Prefix, PathSuffixID, Next-Hop, VirtualHopWeight). The first two entries of the tuple may be matched as described earlier to determine the next-hop, and the VirtualHopWeight is then subtracted from the i-PathID. The VirtualHopWeight, for example, may be the link-weight of the outgoing link if the next-hop is multi-path enabled. Otherwise, it may be the sum of the link-weights (for example) of each link in the path, until a multipath enabled router or destination is found. This value may also be entered in the forwarding table as part of a multi-path computation algorithm (discussed later with respect to FIG. 13).

Turning next to the case having heterogeneous multi-path capabilities, an assumption is made that different multi-path computation approaches may be used at different nodes, and forwarding at a multi-path node may be supported only to a finite and arbitrary number of multi-paths per destination. Further, use of the MPC-bit in LSAs, which allows multi-path enabled nodes to know the subset of nodes that support multi-path capabilities, is assumed.

For the purpose of multi-path computation, each node assumes that other multi-path enabled nodes compute all possible multi-paths as before. However, each node makes an autonomous local decision on (a) how many multi-paths it computes and, (b) how many multi-paths it stores in its forwarding table (a filtering decision). A problem may arise in that a node may assume the existence of a path which, in fact, does not exist due to the autonomous filtering decisions of other multi-path enabled nodes. If packets are sent along this path, a remote multi-path node may re-map the packet to a different path (and in a worst case to the shortest path).

This kind of capability is referred to as best-effort traffic engineering support. In other words, the network makes a best-effort to send the packet on the chosen path, and remaps it to another potential path if the chosen path is not available. Optionally, sources may autonomously check for route existence (e.g., through traceroutes carrying PathIDs).

Referring again to FIG. 2, nodes A, C, and D are multi-path enabled, and node A is the originating node for a packet destined to node F. In this case, however, an assumption is made that D autonomously decides not to store routes D-C-F and D-E-F. When a packet specifying D-C-F (i.e., destination F, iPathID=8) arrives, it is mapped to the nearest match: D-C-E-F (i.e., i-PathID=6). The packet is then forwarded to node C, with i-PathID=3. Node C then matches the packet to the default (shortest path), and observes that node E is not upgraded. Hence, node C sets i-PathID to zero and forwards the packet to node E. Node E ignores the i-PathID (since it is not upgraded) and forwards the packet to node F.

Turning lastly to the hierarchical routing case, it will be appreciated that large OSPF and IS-IS networks support hierarchical routing with up to two levels of hierarchy, with the root area called area 0, and include normal and totally stubby areas. In normal areas, summary LSAs (inter-area) and external LSAs (inter-AS) routes are flooded by area border routers (ABRs). This allows internal nodes to choose an exit ABR, based upon advertised distances to remote areas. In totally stubby areas, however, summary LSAs and external-LSAs are not flooded within the area. In both cases, intra-area nodes cannot see the topology of area 0, or that of other areas. ABRs, on the other hand, can see the topology of area 0, but cannot see the topology of other areas.

In an exemplary embodiment of the present invention, both of these cases are viewed as flat routing domains for purposes of multi-path computation. Multi-paths may be found locally within areas, and crossing areas may be viewed as crossing to a new multipath routing domain. In the case of normal areas, internal nodes may choose an ABR and then decide on multi-paths to that ABR. In the case of totally stubby areas, internal nodes do not have a choice of ABRs since they forward to 0.0.0.0/0 (default route). However, they may choose multi-paths within the area to address 0.0.0.0, resulting in multi-paths to a default exit ABR.

For inter-area multi-path forwarding, the i-PathID field may be re-used after crossing area boundaries. This operation is different from inter-domain multi-path forwarding (described later). For example, if a source needs to send a packet outside an area, it may choose one of the multi-paths to a (default or chosen) area border router (ABR). Then, the ABR may choose among several multi-paths within area 0 to other ABRs. The i-PathID field may be re-initialized by the first ABR at the area-boundary.

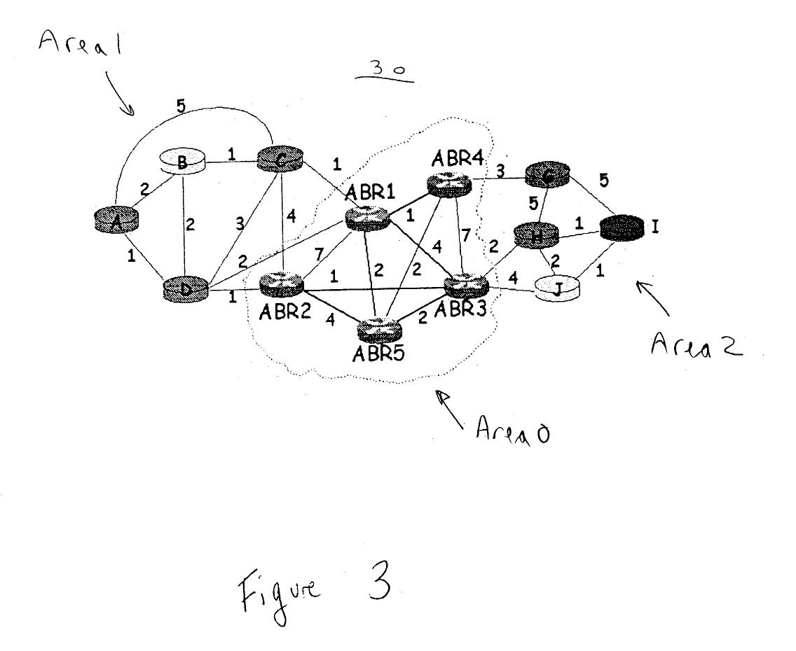

FIG. 3 illustrates hierarchical routing of the present invention in a network, generally designated as 30. As shown, network 30 has three areas (area 1 includes nodes A, B, C, and D; area 0 (which is outlined, includes ABR1-ABR5; and area 2 includes nodes G, H, I, and J). Nodes A, C, and D are multipath enabled, and node A is the originating node. Node A wants to send packets to node I in area 2. ABR1 and ABR2 are the area border routers for area 1. Areas 1 and 2 are assumed to be normal areas, that is, summary-LSAs (and external-LSAs) are flooded into the area. ABR3 and ABR4 flood summary-LSAs into area 0 (advertising reachability to area 2) with costs 7 and 9 respectively (i.e., cost of longest path from the ABR to any node within area 2). ABR1 and ABR2 add their shortest inter-area costs to area 2 and advertise costs of 10 and 8 respectively within area 1. Therefore, nodes A and D choose ABR2 as their exit ABR, whereas nodes B and C choose ABR1 as their exit ABR to reach area 2 destinations. Multi-path enabled nodes A, C, and D, however, may choose either exit ABR. For example, A may choose any of the paths: A-B-C-ABR1-area2, A-B-CABR2-area2, A-D-ABR1-area2, A-D-ABR2-area2, A-D-B-C-ABR1-area2, etc. Assuming that the path prefix [A-B-D- . . . ] is not available, because B does not support multi-path forwarding, node B sends packets with destinations in area 2 to node C. The i-PathID for A-B-C-ABRI-area2 is initially 4 (intra-area)+10(inter-area)=14. The two hops, A-B-C, may be considered a virtual hop having a link weight of 3 for forwarding purpose.

Still referring to FIG. 3, when the packet reaches ABR1, the i-PathID field has a value 10 (which refers to path ABR1-ABR4-area2). Since ABR1 may choose one of many area 0 paths to area 2, however, the i-PathID field set by A may be ignored and reinitialized by ABR1. For example, ABR1 may choose the paths ABR1-ABR5-ABR3-area2, ABR1-ABR3-area2, etc. Assuming it chooses ABR1-ABR5-ABR3-area2, the initial i-PathID is 2+2+7=11, and the next-hop is ABR5. When the packet reaches area2, ABR3 may choose one of many paths to reach I (e.g., ABR3-H-I, ABR3-J-I, ABR3-H-G-I, etc.) and may forward packets, as described before. If the areas are totally stubby areas, all intra-area nodes (multi-path or not) have a default-exit-ABR (i.e., no choice of exit ABR). Multi-paths may be chosen within each area, however, as described before.

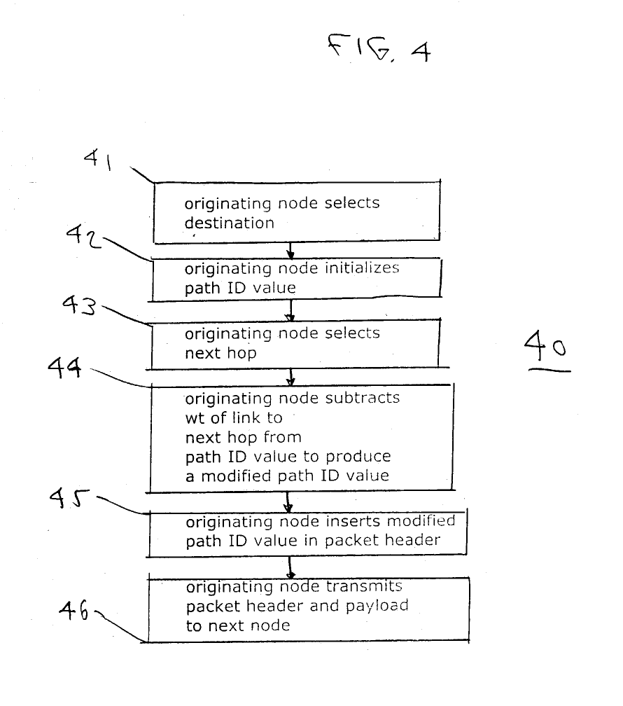

Referring next to FIG. 4, there is shown a method, generally designated as 40, for an originating node to transmit a packet to the next node, in accordance with an embodiment of the invention. As shown in step 41, an originating node, which may be, for example, node A of FIG. 2, selects a destination node to send a packet of data. The destination node may be, for example, node F of FIG. 2. The originating node initializes the path ID in the header of the packet (step 42). As described before, the path ID may be a value of the sum of link weights to the destination node along a route chosen by the originating node. The value of the sum of link weights may be in the form of a hash function. As will be described later, the value may be selected as a hash function of node identifiers and link identifiers (for example link weights).

Having selected the route, as represented by the path ID, the originating node selects, in step 43, the next hop to the next node along the selected route. The next node may be, for example, node D of FIG. 2. Entering step 44, the originating node subtracts the link weight to the next node (assuming that the next node is multi-path capable) from the path ID value to produce a modified path ID value. In the example provided, the link weight to node D is 1. Consequently, assuming that the desired route from originating node A to destination node F is A-D-E-F which has a path ID of 4, the originating node subtracts 1 from 4 to obtain a modified path ID value of 3.

The method enters step 45 in which the originating node inserts the modified path ID value in the packet header and then, in step 46, transmits the packet header and the pay load to the next node. It will be appreciated that, as discussed later, the modified path ID may be a value derived from a hash function of node identifiers and link identifiers and does not have to be a hash function of only link weights.

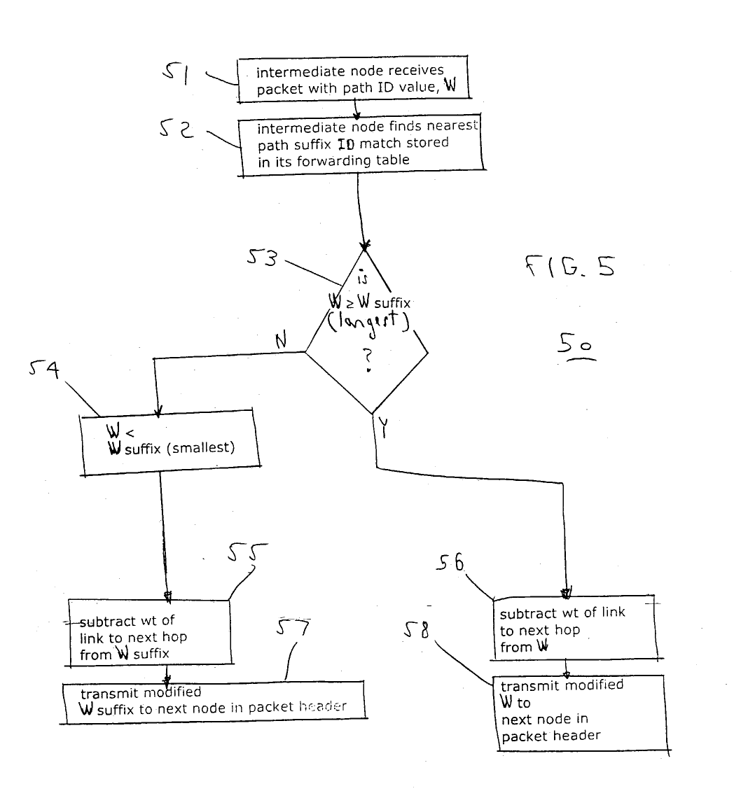

Referring next to FIG. 5, there is shown a method of an intermediate node for selecting another route to a destination node for a packet, in which the packet is received from a previous node, in accordance with an embodiment of the invention. The method of the intermediate node, generally designated as 50, begins in step 51 and receives the packet having a path ID value inserted in a header. The received path ID may have a value of W. The intermediate node, in step 52, finds the closest path suffix ID match that is stored in its forwarding table. The path suffix ID may have a value of Wsuffix.

The method of the intermediate node enters decision box 53 and determines whether the received value W is greater than or equal to the value of Wsuffix. If W is greater than or equal to Wsuffix (the largest value found in the table), the method branches to step 56. The method subtracts the weight of a link (or the weights of multiple links) to the next node (or a node that is multi-path capable) from the value of W in step 56. The method then enters step 58 and transmits the modified value of W to the next node. The modified value of W is inserted in the packet header and transmitted to the next node, together with the payload.

Referring back to decision box 53, if the method determines that W is less than the value of Wsuffix, the method enters step 54 and verifies that the value W is smaller than the smallest Wsuffix stored in the table. The intermediate node then uses Wsuffix as a default value for W. As similarly described in steps 56 and 58, the method enters step 55 and subtracts a link weight (or multiple link weights) to the next node (or multi-path capable node) from the default value of Wsuffix. The method enters step 57 and transmits both the modified path suffix ID (Wsuffix) and the payload to the next node.

It will be understood that method 50, as shown, computes the modified path ID value by subtracting link weight(s) from Wsuffix (step 55) or subtracting link weight(s) from W (step 56). In another embodiment discussed below, method 50 may compute the modified path ID value by using a hash function (for example, a hash of node IDs along the selected route). Thus, subtraction of link weights may not be required.

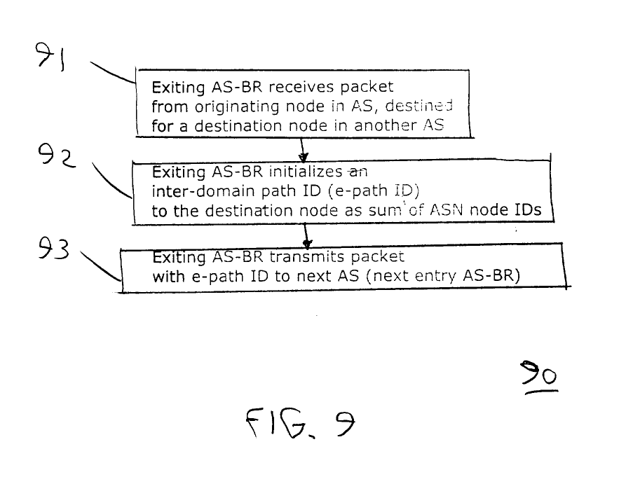

Referring next to FIG. 6, there is shown a method of the invention, generally designated as 60, in which the value of the path ID depends on whether the node (own node or next node) is multi-path capable (MPC) or not MPC. As shown, a node in step 61 receives a packet having a path ID value. The method of the node enters decision box 62 and determines whether the node (own node) supports multi-path capability. If the node does not support multi-path capability, the method branches to step 63 and ignores the received path ID. The method then enters step 64 and forwards, or transmits, the packet using default IP forwarding. The path ID value received from a previous node is not modified by the own node, but simply forwarded to the next node that may be multi-path capable. For example, node B of FIG. 2, which is not multi-path capable, upon receiving a path ID from node A, ignores the path ID and simply forwards the path ID unchanged to the next node D (the only node to whom node B may transmit packets).

If decision box 62, on the other hand, determines that own node supports multi-path capability, the method branches to step 65 and determines the next multi-path capable node on a selected route to a destination. The method, in step 66, calculates the total weight of links to the next multi-path capable node. For example, own node A, upon selecting route A-B-D-F to destination node F in FIG. 2 (path ID value of 6), realizes that node B is not multi-path capable and the next multi-path capable node in the selected path is node D. The method in step 66, thus, calculates the total weight of all the links between node A and node D, as a link weight of 4.

The method enters step 67 and subtracts the total weight of the links from the received path ID to produce the modified path ID. For example, node A in FIG. 2 subtracts the value 4 from the path ID value of 6 to produce the modified path ID value of 2. The method then enters step 68 and transmits the packet including the modified path ID (having the value of 2, for example) to the next node (node B, for example). Since node B (for example) is not multi-path capable, node B ignores the path ID and simply forwards the packet with the received path ID to node D. Node D, however, which is multi-path capable, subtracts the link weight between nodes D and F (2) from the path ID received from node B (2) to produce a path ID of zero. Node D than forwards the packet with the path ID of zero to node F, which is the destination node desired by node A.

Having completed discussion of intra-domain mapping, inter-domain mapping will now be discussed. It will be appreciated that BGP-4 is the inter-domain routing protocol in the Internet. It is a path vector protocol which announces paths to a destination prefix, if the AS is actively using those paths. An inter-domain TE goal of the connectionless framework of the present invention is to enable multi-AS-paths from the source to the destination. Within each transit AS, multi-paths may be chosen under the control of an entry border router (entry AS-BR). An AS may be structured internally as a hierarchical OSPF or IS-IS network; the internal forwarding may then be the same as previously described.

It will be understood that BGP does not disallow multiple AS-path advertisements to any destination prefix. Examination of routing tables from RIPE/NCC, however, indicates that such multi-AS-path announcements do not occur, consistent with single path inter-domain forwarding assumptions. If a single AS is extended to autonomously support multi-AS-path forwarding, it may leverage BGP to advertise multiple AS paths (to any destination prefix) to its neighbor ASs. Therefore, any AS may infer that its neighbor AS has multi-AS-path capabilities from the fact that it is advertising multiple AS-paths (and that the neighbor AS is the forking point for the multi-AS-paths) to the destination prefix of interest.

Moreover, since BGP-4 is a path-vector protocol, the multi-path computation algorithm extension at any BGP router is trivial. BGP-4 applies policies as a series of tie-breaker rules to choose one route to a prefix. A multi-path computation extension allows multiple paths to be chosen, after they are pre-qualified by a set of filtering rules. However, upgrading a single BGP router in an AS is not sufficient. BGP expects synchronization between all i-BGP and e-BGP routers in an AS before routes may be advertised outside the AS. Also, because of the DV-nature of BGP, the multi-AS-path information may not be propagated beyond the immediate neighbors of a multi-AS-path enabled AS. This is because such neighbor ASs may not support multi-path forwarding. As discussed below, simple extensions of BGP may be used to address these issues.

It will be appreciated that there is a distinction between multi-path re-advertisement within an AS (which determines the complexity of upgrades of i-BGP and e-BGP nodes), and readvertisement across AS-boundaries. Across ASs, if neighbor ASs do not relay (re-advertise) at least a subset of the multi-AS-paths available from an AS, remote ASs can not take advantage of such multi-AS-paths. This is a direct result of the path-vector (i.e., extended distance vector) routing paradigm used by BGP-4. Within an AS, the BGP expects synchronization between e-BGP and i-BGP nodes before information is advertised to other ASs.

Moreover, multi-AS-path re-advertisement and multi-AS-path forwarding capabilities at an AS are also distiguishable. In particular, selective multi-AS-path re-advertisement is allowed, even when the AS does not support multi-path inter-domain forwarding internally. In other words, i-BGP and e-BGP routers may store multiple AS-paths to a prefix in their routing information bases (RIBs), and re-advertise them under certain conditions, but they need not support multi-path forwarding entries in their forwarding information bases (FIBS) and need not possess any multi-path data-plane forwarding capabilities.

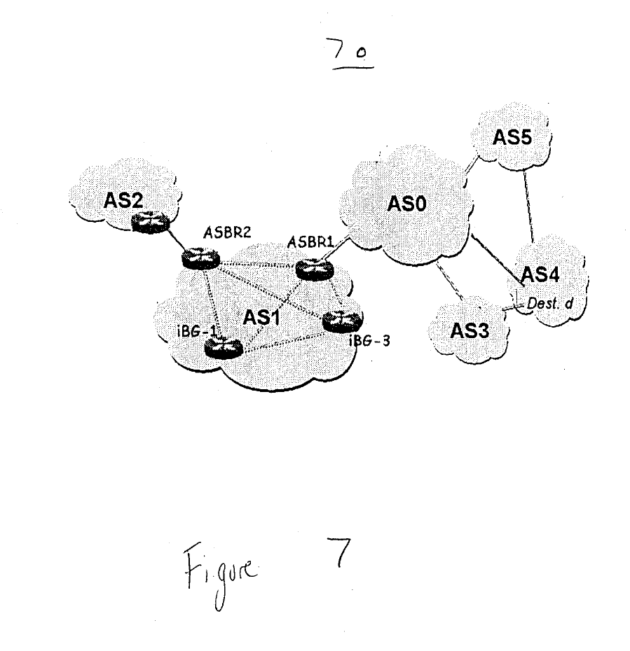

Turning now to BGP multi-AS-Path re-advertisement, an example is provided in FIG. 7 whereby ASO supports and advertises multiple AS paths {p₁, p₂, . . . , pₙ} to destination prefix d. If neighbor AS1 chooses ASO as its next-AS-hop for prefix d (e.g., on the basis of AS-path p₁) it may safely re-advertise all the AS-paths: {(AS1 p₁), (AS1 p₂), . . . , (AS1 pₙ)} even if it does not support multi-AS-path forwarding within AS1. This is possible because, regardless of the source path choice, all traffic to prefix d in AS4 is forwarded to ASO anyway. The particular AS-path choice may be made only at ASO. Hence, AS1 acts as a relay for multi-path traffic, even though it may not possess multi-path forwarding capabilities.

Referring to FIG. 7 there is shown network 70, including ASO having three AS-paths to destination prefix d in AS4. These AS paths may be represented as (0 4), (0 3 4) and (0 5 4). ASO may be configured to announce this to AS1. As an example AS1 may choose AS-path (0 4) as its choice for forwarding packets to destination d. Normally, BGP only announces the AS path (1 0 4) to AS2; however, in the present invention, since AS1 has a forwarding path through ASO, AS1 may re-advertise the other AS-paths to AS2, (i.e., it advertises {(1 0 4), (1 0 3 4), (1 0 5 4)} to AS2).

To avoid ambiguities, however, this re-advertisement may be tagged with a new BGP re-advertisement attribute that lists the ASNs of the ASs that are merely re-advertising AS-paths, and do not support multi-path forwarding. When re-advertising routes, without supporting multi-path forwarding, the AS may append its ASN to the list of re-advertising ASNs. This may allow a remote AS to unambiguously identify the ASs which support multi-path forwarding. A neighbor of AS1 (for example AS2) may now parse and interpret these re-advertisements to mean that the remote autonomous system, ASO, supports multi-AS-paths (because it is a forking point for the AS-paths). Furthermore, it now knows that AS1 is merely re-advertising these AS-paths.

Considering next BGP synchronization issues, BGP-4 semantics requires that re-advertisement capability be supported by both i-BGP and e-BGP routers before the entire AS may be declared to have re-advertisement capability. In particular, both i-BGP and e-BGP routers store multiple AS-paths for prefixes in the RIBS, but not necessarily in the FIBS. An alternative may be to weaken BGP's synchronization assumption between i-BGP and e-BGP, and require only the e-BGP nodes to synchronize on these re-advertisements. This method may require that inter-domain multi-path packets be tunneled through an AS from its entry AS-BR to its exit AS-BR.

In either of these embodiments, the first e-BGP AS-BR (that sees multi-path advertisements from neighbor ASs) may make a decision on a prefix-by-prefix basis whether to re-advertise AS-paths. In other words, the first AS-BR may decide to re-advertise the AS-paths {(AS1 p₁), (AS1 p₂), . . . , (AS1 pₙ)} once it accepts pᵢ. It may also decide to re-advertise only a subset of the AS-paths. Other BGP routers in the AS may then relay such re-advertisements and populate their RIBS.

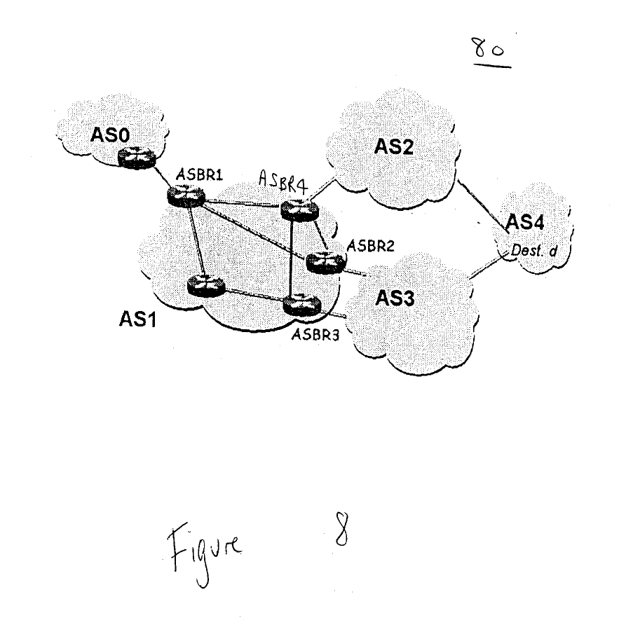

To illustrate multi-path forwarding across transit ASs, consider network 80 shown in FIG. 8 as an example. As shown, ASO is a customer AS that buys transit from AS1 and has traffic to destination d in AS4.

Still referring to FIG. 8, the exit AS-BR (AS border router) of ASO initializes a new packet header field, the inter-domain PathID (or e-PathID) to specify its AS-path choice to destination d. The e-PathID for BGP is defined, for example, as the sum of the AS numbers (ASNs) of the ASs on the path modulo 2^{b} where b is the e-PathID field length in bits. In this embodiment e-PathID is a sum of node IDs, and is different from an i-PathID, which is a sum of link weights. Accordingly, all intermediate ASs may compute PathSuffixIDs as a sum of ASNs of AS-path-suffixes, and may subtract their own ASN (or next-virtual-AS-hop ASN sum) from the e-PathID during inter-domain forwarding (i.e., at the entry AS-BR).

In an exemplary embodiment of the present invention, the e-PathID field size may be 32 bits, because currently ASNs use a 16-bit space, and only the lower portion of the ASN space is allocated. Moreover, unlike link-weights, ASNs are likely to be unique, since they are identifiers for autonomous systems. Hence, the e-PathID (which is the sum of unique ASNs) and the inter-AS forwarding tuple (destination, e-PathID) have a high probability of being unique.

Still referring to FIG. 8, the entry AS-BR (ASBR1) of transit provider AS1 uses the inter-domain forwarding tuple (destination, e-PathID) to determine the next AS-hop, i.e., the next AS to which the packet has to be transmitted. It is assumed that AS1 is multi-path forwarding enabled and has two AS-paths to destination d (or its prefix), namely one path through peer AS2 and another path through peer AS3. If ASO chooses the path (0 1 3 4), it may initialize e-PathID to 8 to indicate a next-AS-hop of AS3 at ASBR1. Moreover, in the example shown, AS1 has two ASBRs (ASBR2 and ASBR3) peering with AS3.

First, it may be appreciated that the entry ASBR (ASBR1) is the only node that processes and updates the e-PathID field by subtracting its own ASN of the next-AS-hop. The entry-ASBR may update the e-PathID by subtracting the sum of ASNs of AS hops which are known not to support multi-path forwarding (i.e., Virtual-AS-Hop ASN). The inter-domain forwarding table at the entry AS-BR may include a list of tuples: (Destination prefix, AS-PathSuffixID, Next-AS-Hop, Virtual-AS-Hop-ASN). A minor difference in e-PathID processing is that packets with errant e-PathIDs may be mapped to a default AS-path, which may or may not be the shortest AS-path available (i.e., chosen by policy as in current BGP).

It will also be appreciated that the above inter-domain forwarding does not resolve the intra-AS transit forwarding. A possibility is to encapsulate (tunnel) the packets across the AS, with the chosen exit AS-BR address as the destination address, and the chosen intra-domain PathID in the outer header. The inter-domain forwarding tuples at entry-ASBRs may have the form: (Destination prefix, AS-PathSufxID, exit AS-BR, Virtual-AS-Hop-ASN).

The exit AS-BR may then de-capsulate the tunneled packet and perform e-PathID processing as discussed above. No new forwarding plane support is needed from internal iBGP routers in the path (over-and-above optional intra-domain multi-path support discussed in previous sections).

An alternative transit forwarding strategy may be to add a new field for the exit AS-BR address in the routing option. This field may be an addition to the previously discussed i-PathID and e-PathID fields. Internal i-BGP routers of AS1 may be configured to ignore the destination address and simply use the exit AS-BR field as the destination, and an i-PathID to specify the particular path to the exit AS-BR. This approach is similar to the encapsulation approach, except that the AS-BR address is put into the routing, and the overhead of the outer IP header fields is avoided. This requires, however, that all internal i-BGP routers support this enhanced forwarding plane. The exit-ASBR field may be 32-bits for both IPv4 and IPv6. The field may include the exit AS-BR IPv4 address (for IPv4), and a condensed (or locally mapped) version of the IPv6 address (for IPv6).

Partial upgrade strategy in BGP may start with a re-advertisement capability (only at e-BGPs, or in both e-BGP and i-BGP). Then forwarding capabilities may be provided only at e-BGP routers (tunneled case) or all upgraded routers (exit AS-BR case).

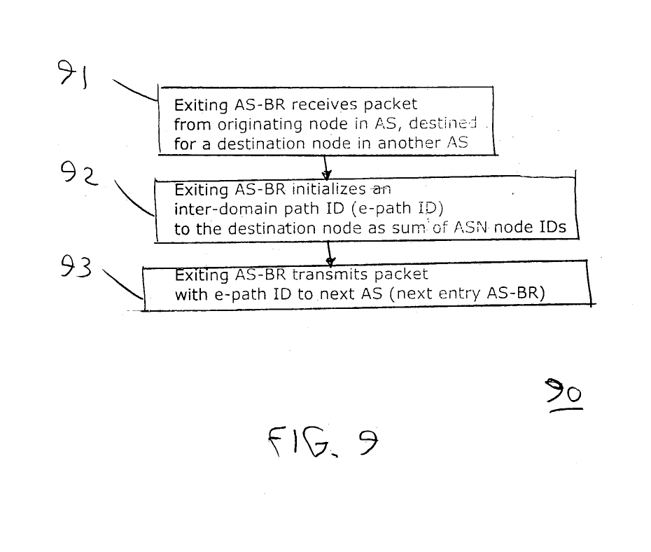

Referring next to FIG. 9, there is shown method 90 for inter-domain routing used by an exiting AS-border router (AS-BR) to another AS, in accordance with an embodiment of the invention. As shown, the method enters step 91, in which the exiting AS-BR receives a packet from an originating node. It will be appreciated that the originating node belongs to the same AS, as the exiting AS-BR, and the packet is destined to a node in another AS. Since the received packet is destined for a destination node in another AS, the method enters step 92 and initializes an inter-domain path ID (or e-path ID) to the destination node. The e-path ID is initialized to have a value of the sum of AS node IDs between the originating AS and the destination AS (containing the destination node). The method then enters step 93 in which the exiting AS-BR transmits the packet with the initialized e-path ID to the next AS (that is, the next entry AS-BR).

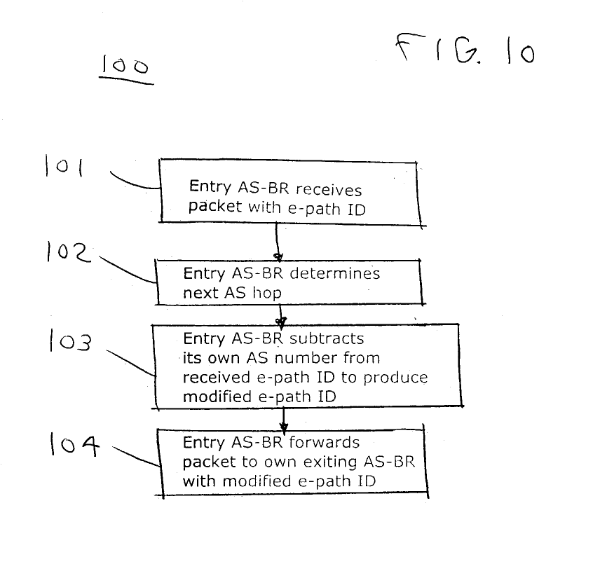

Referring next to FIG. 10, there is shown method 100 for an entry AS-BR to use in forwarding a packet received from an exiting AS-BR of another AS, in accordance with an embodiment of the invention. As shown, the method enters step 101 and receives the packet with the e-path ID. Entering step 102, the entry AS-BR determines the next AS to send the packet on its way to the destination node. The entry AS-BR, in step 103, subtracts its own AS number from the received e-path ID and produces the modified e-path ID. Finally, in step 104, the entry AS-BR forwards the packet to its own exiting AS-BR with the modified e-path ID.

As an example, AS0 of FIG. 8 wishes to forward a packet to destination node d in AS4. AS0 may choose path AS0-AS1-AS2-AS4. An exiting AS-BR in AS0 may transmit the packet to AS1 with the path ID of 1 2 4 (having subtracted 0 from the initial path ID). The entry AS-BR1 of AS1 may modify the received path ID of 1 2 4 by subtracting its own AS number of 1. The modified e-path ID is now 2 4. The entry AS-BR1 of AS1 may forward the packet by tunneling (for example) directly to exiting AS-BR4 with the path ID of 2 4. Exiting AS-BR4 may then forward the packet to AS2, and so on.

In summary, the connectionless framework of the present invention supports both intradomain and inter-domain paths, which may be encoded in, for example, three 32-bit fields in packet headers. This exemplary per-packet overhead is smaller than a 128-bit IPv6 address. The i-PathID may be used for intra-AS multi-path forwarding, and may be re-initialized after crossing area or AS boundaries. The i-PathID may be, for example, the sum of link weights on the path suffix. The e-PathID may be, for example, the sum of ASNs on the ASpath-suffix, and may be processed only at AS-boundaries. The exit-ASBR field may be used for transit forwarding within an AS. This field is not required, however, if packets are tunneled across ASs from an entry ASBR to an exit AS-BR.

The intra-domain forwarding tables at upgraded routers may have tuples (Destination prefix, PathSuffixID, Next-Hop, VirtualHopWeight), for example, which are indexed after processing the forwarding tuple (Destination, i-PathID) for longest prefix destination match and nearest-PathID match. The value VirtualHopWeight may be subtracted from the i-PathID packet field. Packets with errant i-PathIDs may be mapped to the shortest path, and their i-PathID may be re-initialized. OSPF LSA's may be extended with one bit to indicate whether the router is multi-path capable (MPC).

In distance-vector protocols, on the other hand, the lack of topology visibility may allow only simple multi-path algorithms under partial upgrades, which may not compute all available multi-paths.

The inter-domain forwarding at entry AS-BRs (i.e., e-BGP routers) may have tuples (Destination Prefix, AS-PathSuffixID, exit AS-BR, Virtual-AS-Hop-ASN), which are indexed by processing the inter-domain forwarding tuple (Destination, e-PathID) for longest-prefix destination match and nearest-PathID match. The value Virtual-AS-Hop-ASN may be subtracted from the e-PathID packet field. A difference compared to the intra-domain routing is that packets with errant e-PathIDs may be mapped to a default AS-path which may or may not be the shortest AS-path available (i.e., chosen by policy). The exit AS-BR value may be used to initialize the tunnel header destination in the exit-ASBR field. The i-PathID field may be re-initialized to specify a transit intra-domain path through the AS.

Since BGP is a path-vector protocol, re-advertisement of multi-paths is critical for remote ASs to discover the available multi-AS-paths. The connectionless framework of the preset invention may filter re-advertisement of AS-paths through a neighbor, if the AS indeed forwards packets via the particular neighbor AS. The connectionless framework advantageously allows a partial upgrade strategy of eBGP routers alone, provided BGP synchronization semantics can be weakened, and tunneling of packets between eBGP routers is possible. Unlike the intra-domain case, computation of multi-paths is trivial because paths are explicitly advertised in BGP. Forwarding from the entry-ASBR to the exit-ASBR can be either through tunneling or through special forwarding capabilities (using exit-ASBR field as destination) at all i-BGP routers.

The connectionless framework facilitates progressive decision making by nodes along the path that may take on the role of a source on behalf of the originating host (e.g., source host, first-hop router, ABR, AS-BR in source AS, entry AS-BR in transit domains). Such sources have visibility into paths, and may make decisions on behalf of the original source.

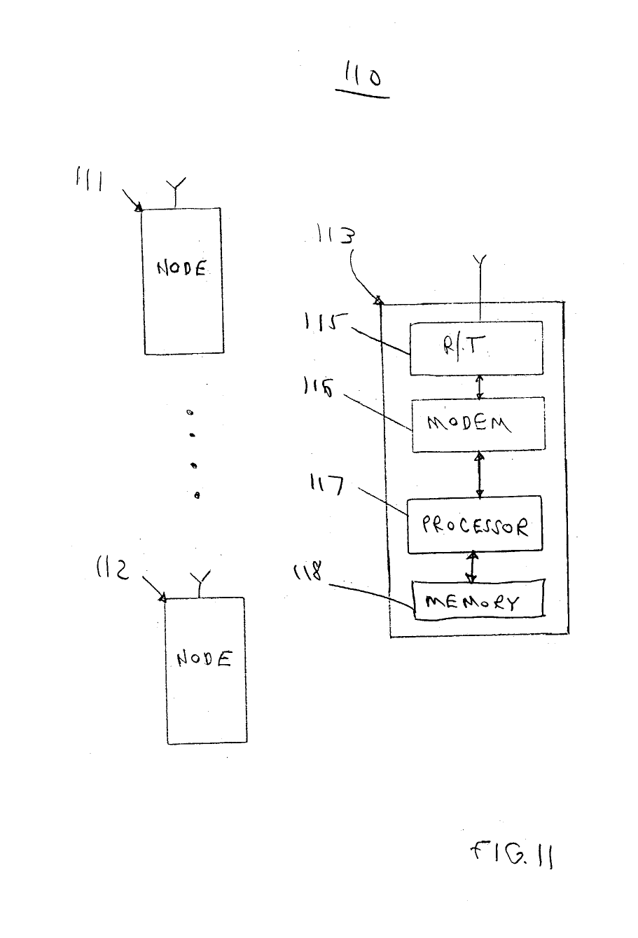

Referring next to FIG. 11, there is shown network 110, including at least nodes 111, 112 and 113, each using the connectionless framework of the present invention. Each node (for example node 113) includes receiver/transmitter 115 coupled, by way of modem 116, to processor 117. The processor is configured to execute methods of the present invention, such as initializing or modifying a path ID value in a packet header. The tuples entered in the forwarding tables may be stored in memory 118.

FIG. 13 illustrates an exemplary link state algorithm for an upgraded node i that uses a network map (graph) and executes an all-pairs shortest path computation, i.e., the Floyd-Warshall Algorithm. For any chosen node k and destination j, the Floyd-Warshall algorithm sets up the next-hop node I in the shortest path in node k's routing table. Given these routing tables, a depth-first search (DFS) is done rooted at node i to discover multiple paths from i to each destination j.

The algorithm uses a per-node variable visited_nodes, within each DFS pass, to mark the nodes visited by the DFS algorithm. By only picking nodes which have not been visited earlier to construct the paths, loop-free paths may be ensured. If the DFS algorithm arrives at node k (and appended k to relevant paths), it considers a subset of k's neighbors. If node k is known to be multi-path enabled, the DFS considers all of its neighbors. Otherwise, it considers the next-hop node on the shortest path from k to the destination. If the chosen next-hop node of k has not been visited earlier, it appends this node to the path, and repeats the above procedure recursively, using k's next-hop node as the source. Once the DFS is complete at node k, then the visited_nodes[k] is reset to zero. With minor extensions, the algorithm may be used to obtain the VirtualHopWeight using a variable flag (initialized as true) for each path. The link weights may be added to VirtualHopWeight, if the flag is set. The variable flag may be reset, if the next hop is a multi-path capable node.

The computational complexity of a sequential Floyd-Warshall implementation is O(N³) where N is the number of nodes in the network. However, it has been shown that this shortest path problem may be viewed as a matrix multiplication problem that can be solved in O(n^{w}), (w<2.5) The best known upper bound is 0(n^{2.376}). Alternatively, one may run Dijkstra (N−k) times where k is the number of multi-path capable nodes. The Dijkstra's algorithm with adjacency lists has complexity of O(Elog(N)), so varying over N−k source nodes gives a complexity of O((N−k)Elog(N)).

The connectionless framework has been described herein through various exemplary embodiments. Although routes or paths for a packet of data have been described using PathID {i.e., PathID(i, j, w₁, . . . , wₘ)}, wherein the path ID is a modulo function of link weights, the value of the PathID is not limited thereto. Rather, the PathID may be another hashing function. For example, in a path from node i to node j, where node k is an intermediate node, and m−1 is a node adjacent to node j (with a link weight between node m−1 and node j being wₘ), the path ID may be defined as a sequence of globally known node IDs and link weights:

Path ID from i to j: ={i, w₁, 1, w₂, 2, . . . , wₖ, k, wₖ₊₁, . . . , wₘ, j}

A possible hash function may be the sum of node IDs, such as:

[j, {h(1)+h(2)+ . . . +h(k)+ . . . +h(m−1)}mod 2^{b}],

where j is the destination.

Hashing a sequence of globally known quantities enables avoidance of signaling because each upgraded router in the path may unambiguously interpret the hash, and compute the hash independently.

The choice of a hashing function may be dictated by the desire to minimize collision probability. A simple hash of the path sequence may be obtained, for example, by using the sum or XOR function. An advantage of a simple hash is that the PathID computation is simple and fast; however, it may lead to non-unique path-IDs for different paths. In an exemplary embodiment of the present invention, a 128-bit MD5 hash of the nodeIDs may be used along the path, followed by a 32-bit CRC of the 128-bit MD5 hash to result in a 32-bit hash field. For example, the notation (MD5+CRC32) hash may be used to represent the two step hashing process. The PathID, along with a destination address (e.g., j) may be used to forward a packet at the intermediate routers. If the sequence of node IDs along the path is unique (assuming, for simplicity, that adjacent nodes do not have multiple links), then by the properties of the MD5 and CRC-32 hash functions, the tuple=[j, PathID] is very highly likely to be unique (i.e., the collision probability <1 in 8 million).

Although illustrated and described herein with reference to certain specific embodiments, the present invention is nevertheless not intended to be limited to the details shown. Rather, various modifications may be made in the details within the scope and ranges of equivalence of the claims and without departing from the spirit of the invention.

What is claimed:

1. In a network of nodes connected by links, including first and second nodes, a method of routing a packet to a third node comprising the steps of:
(a) receiving, in the second node, the packet from the first node, the packet including a value representing a route of nodes connected by links to a destination node;
(b) modifying, in the second node, the received value to produce a modified value representing another route of nodes connected by links to the destination node; and
(c) transmitting the packet including the modified value, from the second node to the third node.

2. The method of claim 1 in which links are identified by link weights,
step (a) includes receiving the value as a sum of link weights of links connecting nodes along the route to the destination node, and
step (b) includes modifying the value to produce the modified value as another sum of link weights of links connecting nodes along the other route to the destination node.

3. The method of claim 2 in which
step (a) includes receiving the value as a hash function, and
step (b) includes encoding the modified value using the hash function.

4. The method of claim 2 in which the first, second and third nodes are along the route, and
the second and third nodes are along the other route.

5. The method of claim 1 in which links are identified by link weights and nodes are identified by node numbers,
step (a) includes receiving the value as a hash function of at least one of node numbers and link weights of respective nodes and connecting links along the route to the destination node, and
step (b) includes encoding the modified value using the hash function of at least one of node numbers and link weights of respective nodes and connecting links along the other route to the destination node.

6. The method of claim 1 in which at least one link between the second and third nodes is represented by a second-to-third link weight, and
step (b) includes modifying the received value using the second-to-third link weight to produce the modified value.

7. The method of claim 6 in which step (b) includes subtracting the second-to-third link weight from the received value to produce the modified value.

8. The method of claim 1 in which
step (a) includes receiving the packet, wherein the packet includes a payload and a header, the header including the value and an identification of the destination node, and
step (c) includes transmitting the packet, wherein the packet includes the payload and a header, the header including the modified value and the identification of the destination node.

9. The method of claim 1 in which at least one link between the second and third nodes is represented by a second-to-third link weight,
the method including the steps of:
(d) storing in a table, in the second node, a plurality of path suffix values, each path suffix value representing a possible route of nodes connected by links from the second node to the destination node;
(e) selecting, in the second node, the largest path suffix value stored in the table;
(f) comparing, in the second node, the largest path suffix value to the value received in step (a); and
step (b) includes modifying the received value using the second-to-third link weight to produce the modified value, if the largest path suffix value is smaller than or equal to the received value.

10. The method of claim 1 in which at least one link between the second and third nodes is represented by a second-to-third link weight,
the method including the steps of:
(d) storing in a table, in the second node, a plurality of path suffix values, each path suffix value representing a possible route of nodes connected by links from the second node to the destination node;
(e) selecting, in the second node, the smallest path suffix value stored in the table;
(f) comparing, in the second node, the smallest path suffix value to the value received in step (a); and
step (b) includes modifying the smallest path suffix value using the second-to-third link weight to produce the modified value, if the smallest path suffix value is greater than the received value.

11. The method of claim 1 in which step (c) includes transmitting the modified value and a payload together in the packet, free-of signaling protocol setting up the other route.

12. The method of claim 1 in which at least a fourth node is disposed along the route between the second node and the third node,
a link between the second node and the fourth node is represented by a second-to-fourth link weight, and
a link between the fourth node and the third node is represented by a fourth-to-third link weight; and
the method further including the steps of:
(d) determining, in the second node, if the at least fourth node is multi-path capable; and
step (b) includes modifying the received value using both, the second-to-fourth and fourth-to third link weights, to produce the modified value, if step (d) determines that the fourth node is not multi-path capable.

13. The method of claim 12 in which step (b) includes subtracting the second-to-fourth and fourth-to third link weights from the received value to produce the modified value.

14. The method of claim 12 wherein step (d) includes receiving, in the second node, a link state advertisement (LSA) from the fourth node advertising that the fourth node is not multi-path capable.

15. A node configured to communicate in a network of nodes connected by links, the node comprising:
a receiver configured to concurrently receive a packet of data and a path ID from a previous node, the path ID representing a desired route for the packet of data, the desired route transversing nodes that are connected by links to a destination node,
a memory configured to store multiple path suffix IDs, each path suffix ID representing a possible route for the packet of data from the node to the destination node,
a processor configured to modify the received path ID using the multiple path suffix IDs stored in the memory, and
a transmitter configured to concurrently transmit the packet of data and the modified path ID to a next node disposed along one of the possible routes.

16. The node of claim 15 wherein the next node includes a node number,
a link between the node and the next node includes a link weight, and
the processor is configured to modify the path ID using at least one of the node number and the link weight.

17. The node of claim 15 wherein a field is stored in the memory for identifying that the node is multi-path capable, and
the transmitter is configured to transmit the field to other nodes in the network for identifying that the node is multi-path capable.

18. The node of claim 15 wherein the processor is configured to encode the modified path ID using a hash function.

19. The node of claim 15 wherein the node is one of a router and an autonomous system (AS) node.

20. A machine-readable storage medium containing a set of instructions for causing a node, configured to receive and transmit packets in a communication network of nodes connected by links, to perform the following steps:
(a) receiving a packet from a previous node, the packet including both a payload and a value representing a desired route of nodes connected by links to a destination node;
(b) modifying the received value to produce a modified value representing another route of nodes connected by links to the destination node; and
(c) transmitting the packet including both the payload and the modified value to a next node along the other route.

21. The medium of claim 20 wherein step (b) includes encoding the modified value using a hash function.
